(19) United States
(12) Patent Application Publication
(10) Pub. No.: US 2017/0089259 A1
(43) Pub. Date: Mar. 30, 2017

(54) COMPOSITE THERMAL BARRIER FOR INTERNAL COMBUSTION ENGINE COMPONENT SURFACES

(71) Applicant: Corning Incorporated, Corning, NY (US)

(72) Inventors: Dana Craig Bookbinder, Corning, NY (US); Pushkar Tandon, Painted Post, NY (US); Christopher John Warren, Waverly, NY (US)

(21) Appl. No.: 15/278,515

(22) Filed: Sep. 28, 2016

Related U.S. Application Data
(60) Provisional application No. 62/235,008, filed on Sep. 30, 2015.

(51) Int. Cl. F02B 77/11

(52) U.S. Cl. CPC F02B 77/11

(57) ABSTRACT

A composite thermal barrier and methods of applying the composite thermal barrier to a metallic surface within a combustion chamber of an engine. The composite thermal barrier includes an insulation material contained within a metallic web. The metallic web is formed on a surface within the combustion chamber of the engine.

This application claims the benefit of priority under 35 U.S.C. §119 of U.S. Provisional Application Ser. No. 62/235,008 filed on Sep. 30, 2015, the content of which is relied upon and incorporated herein by reference in its entirety.

### BACKGROUND

Field

The present disclosure relates generally to composite thermal barriers for combustion chamber component surfaces in an internal combustion engine.

Technical Background

The efficiency of internal combustion engines may be improved by retaining heat from ignited fuel in the combustion chamber. This can be accomplished by minimizing heat loss to the surrounding engine. One solution has been to insulate parts of the combustion chamber. A problem with insulating the combustion chamber from the surrounding engine may be creating a reliable bond between the thermal barrier and combustion chamber component surfaces.

Accordingly, a need exists for improved thermal barriers within internal combustion engines.

### SUMMARY

According to one embodiment of the present disclosure, a composite thermal barrier is disclosed. In embodiments, the composite thermal barrier comprises a metallic web and an insulation material. In embodiments, the metallic web includes a metal and a void space. In embodiments, the metallic web also includes a volume is defined by a length, a width, and a thickness. In embodiments, the metallic web is connected to a metallic surface within a combustion chamber of an engine. In embodiments, the insulation material is contained within the void space of the metallic web.

According to another embodiment of the present disclosure, a composite thermal barrier is disclosed. In embodiments, the composite thermal barrier comprises a metallic web and an insulation material. In embodiments, the metallic web includes a metal and a plurality of voids and is defined by a length, a width, and a thickness. In embodiments, the metallic web is connected to a metallic component within the combustion chamber of an engine. In embodiments, the insulation material is contained within the plurality of voids of the metallic web.

According to yet another embodiment of the present disclosure, a method of applying a composite thermal barrier is disclosed. In embodiments, the method includes preparing a metallic surface within a combustion chamber of an engine for application of the composite thermal barrier. In embodiments, the method includes applying the metallic web including void space to the metallic surface. In embodiments, the method includes inserting the insulation material within the void space of the metallic web.

Before turning to the following Detailed Description and Figures, which illustrate exemplary embodiments in detail, it should be understood that the present inventive technology is not limited to the details or methodology set forth in the Detailed Description or illustrated in the Figures. For example, as will be understood by those of ordinary skill in the art, features and attributes associated with embodiments shown in one of the Figures or described in the text relating to one of the embodiments may well be applied to other embodiments shown in another of the Figures or described elsewhere in the text.

### BRIEF DESCRIPTION OF THE DRAWINGS

The disclosure will be better understood, and features, aspects and advantages other than those set forth above will become apparent when consideration is given to the following detailed description thereof. Such detailed description makes reference to the following drawings.

FIG. 1 is a cross-sectional view of a combustion chamber in an engine during an intake stroke according to an exemplary embodiment.

FIG. 2 is a cross-sectional view of the combustion chamber in the engine of FIG. 1 during an exhaust stroke according to an exemplary embodiment.

FIG. 3 is a plot of change in brake thermal efficiency (%) of an internal combustion engine at cruise operating conditions vs. piston thermal conductivity at 400° C. (W/m·° C.).

FIG. 4 is a close-up, cross-sectional view of a metallic web on a surface within a combustion chamber of an engine according to an exemplary embodiment.

FIG. 5 is a close-up, cross-sectional view of a composite thermal barrier including the metallic web from FIG. 4 on a surface within a combustion chamber of an engine according to an exemplary embodiment.

FIGS. 6-9 are close-up, cross-sectional views of composite thermal barriers on a surface within a combustion chamber of an engine according to exemplary embodiments.

FIG. 10 is a perspective view photograph of a composite thermal barrier with a metallic skin (partially removed on the right side) on a coupon simulating a surface within a combustion chamber of an engine according to an exemplary embodiment.

FIG. 11 is a top view photograph of a composite thermal barrier with a metallic skin (partially removed on the right side) on a coupon simulating a surface within a combustion chamber of an engine according to an exemplary embodiment.

### DETAILED DESCRIPTION

Unless defined otherwise, all technical and scientific terms used herein have the same meaning as commonly understood by one of ordinary skill in the art to which the disclosure belongs. Although any methods and materials similar to or equivalent to those described herein can be used in the practice or testing of the present disclosure, the exemplary methods and materials are described below.

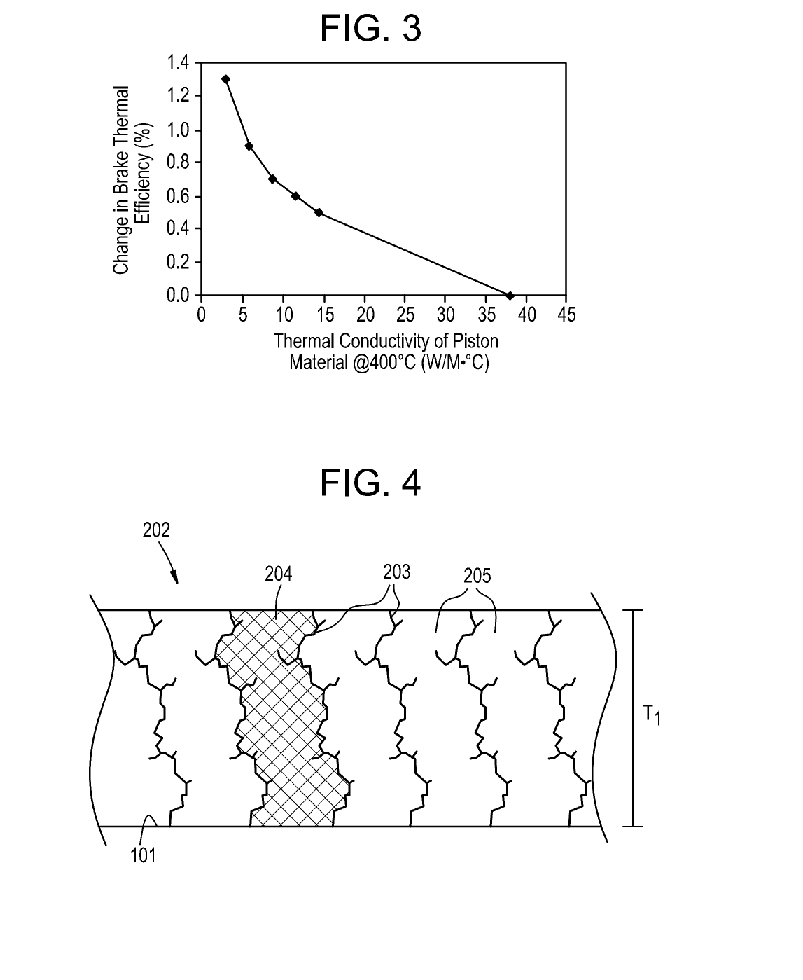

Engine fuel efficiency is affected by the thermal conductivity of the materials used to make the various components of an engine. This is particularly true for components within the combustion chamber of an engine (e.g., wall of the combustion chamber, pistons, valves, exhaust ports, manifolds, etc.). The higher the thermal conductivity of materials used in the combustion chamber, the more combustion energy lost to heat energy. By lowering the thermal conductivity of materials directly exposed to the combustion reaction, more energy of combustion is available for performing work and powering the engine (i.e., to drive the piston). That is, heat of combustion that is not lost to heat energy can be used to drive a turbocharger in the exhaust manifold and/or more effectively light off the catalytic converter during a cold-start of the engine. Accordingly, the overall efficiency of the engine (including fuel efficiency) may be improved with thermally resistant materials. FIG. 3 provides a plot of change in brake thermal efficiency (%) of an internal combustion engine at cruise operating conditions vs. the piston material's thermal conductivity at 400° C. (W/m·° C.). FIG. 3 illustrates the effect of piston material thermal conductivity on brake thermal efficiency of an engine at cruise operating conditions. The trend of FIG. 3 evidences that the increase in efficiency of an engine at cruise conditions may improve exponentially by reducing the thermal conductivity of materials (for the appropriate temperature range) used within the combustion chamber.

Conventional methods for lowering the thermal conductivity of materials within the combustion chamber have included the use of thermal barriers. Conventional thermal barriers for combustion chambers of internal combustion engines may have one or more of several problems. One major shortcoming for conventional thermal barriers may be that the thermal barrier spalls or separates from the surface within the combustion chamber when exposed to the violent combustion kinetics, high pressures (e.g., 10 bars-200 bars), and high temperatures (e.g., 1000° C.-3000° C.) therein. Spalling of thermal barriers including brittle ceramic materials into the combustion chamber can cause damage (e.g., gouge, plug, etc.) to other engine components and the catalytic convertor. Another shortcoming of conventional thermal barriers may be insufficient thermal resistivity properties or a different coefficient of thermal expansion (CTE) than the combustion chamber surface which may lead to separation at high temperatures. Yet another shortcoming may be non-uniform thicknesses of conventional thermal barriers on engine component surfaces.

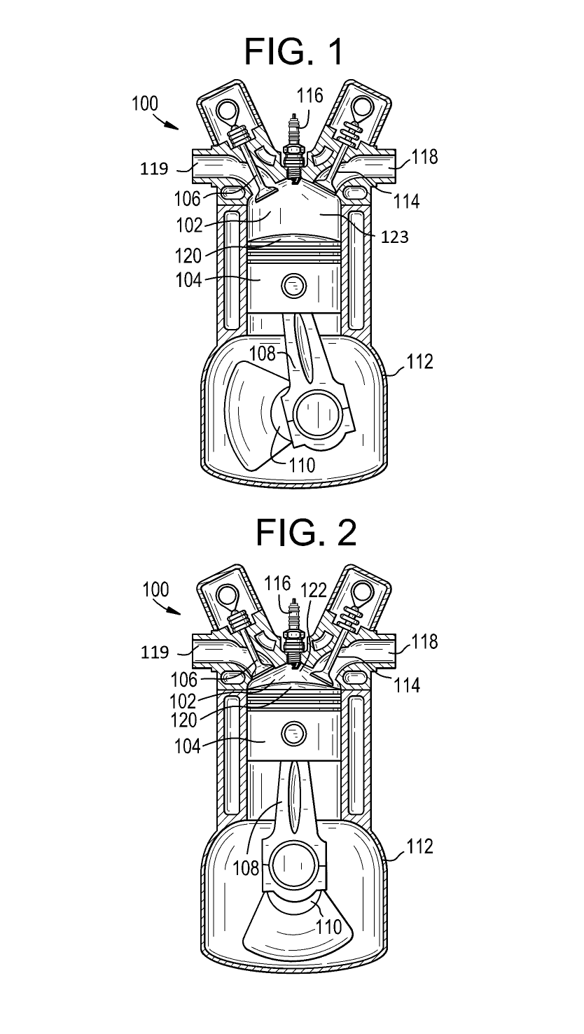

The present application is directed to a composite thermal barrier 200 on any metallic surface within an internal combustion engine 100. FIG. 1 provides a cross-sectional view of example engine 100 during an intake stroke. FIG. 2 provides another cross-sectional view of example engine 100 with piston 104 in a full-exhaust stroke position. Engine 100 of the present disclosure may be gasoline, diesel, natural gas, propane, or any other liquid or gas hydrocarbon powered internal combustion engine. Engine 100 includes a number of components including a combustion chamber 102 with a piston 104 therein. Piston 104 is connected to a crankshaft 110 by a connecting rod 108 within a crankcase 112 of engine 100. Piston 104 includes a top surface 120 adjacent combustion chamber 102. Piston top surface may be flat or domed. Piston 104 may be made from carbon steel, aluminum, or other metals typically used in automotive applications. An intake valve 106, an intake duct 119, an exhaust valve 114, an exhaust duct 118, and a spark/glow plug 116 are also adjacent combustion chamber 102. Of course other components and configurations of engine 100 are possible and are in accordance with the present disclosure.

In FIG. 2, intake valve 106 is closed and exhaust valve 114 is open (when piston 104 is at a full-exhaust stroke position) connecting exhaust duct 118 with combustion chamber 102 and thereby forming a chamber exhaust volume 122. Chamber exhaust volume 122 is defined by wall surfaces and end surfaces of combustion chamber 102, a surface of intake valve 106, a surface of exhaust valve 114, top surface 120 of piston 104, and walls of exhaust duct 118. In another embodiment, intake valve 106 and exhaust valve 114 are closed (when piston 104 is at a full-compression stroke position) thereby forming a chamber compression volume 121 (not shown). Chamber compression volume 121 is defined by walls and top surfaces of combustion chamber 102, a surface of intake valve 106, a surface of exhaust valve 114, and top surface 120 of piston 104. In yet another embodiment, intake valve 106 is open and exhaust valve 114 is closed (when piston 104 is at a full-intake stroke position) connecting intake duct 119 with combustion chamber 102 and thereby forming a chamber intake volume 123. Chamber intake volume 123 is defined by wall surfaces and end surfaces of combustion chamber 102, a surface of intake valve 106, a surface of exhaust valve 114, top surface 120 of piston 104, and walls of intake duct 119.

Composite thermal barrier 200 of the present disclosure may be on any metallic surface within engine 100. In an exemplary embodiment, composite thermal barrier 200 is on a metallic surface 101 within combustion chamber 102. Metallic surface 101 may be surfaces defining compression exhaust volume 121, surfaces defining chamber exhaust volume 122, or surfaces defining chamber intake volume 123. In one embodiment, surface 101 may not be wall surfaces of combustion chamber 102 contacted by piston 104. That is, composite thermal barrier 200 may be excluded from surfaces in chamber 102 subjected to mechanical friction from piston 104 or areas along the crevice quench that may wear or separate composite thermal barrier 200 from that surface. In another exemplary embodiment, metallic surface 101 is piston top surface 120, wall surfaces and end surfaces of combustion chamber 102, a surface of intake valve 106, a surface of exhaust valve 114, walls of exhaust duct 118, or walls of intake duct 119.

Composite thermal barrier 200 of the present disclosure includes a metallic web 202 and an insulation material 204. Metallic web 202 includes a metal 203 and a void space 205. Metallic web 202 also includes a volume defined by a length, a width, and a thickness T1. That is, metal 203 and void space 205 of metallic web 202 together may delineate the volume of metallic web 202 (referred to herein as metallic web 202 volume). Void space 205 also has a smaller volume within metallic web 202 volume (referred to herein as void space 205 volume). In one embodiment, metallic web 202 volume includes from about 1% to 95% metal 203. In alternative embodiments, metallic web 202 volume may be from about 1% to about 90% metal 203, or from about 2% to about 80% metal 203, or from about 3% to about 70% metal 203, or even from about 4% to about 60% metal 203. Accordingly, metallic web 202 volume may be from 5% to about 99% void space 205, or about 10% to about 99% void space 205, or from about 20% to about 98% void space 205, or even from about 30% to about 97% void space 205. Void space 205 may extend across the entire thickness T1 of metallic web 202. In alternative embodiments, void space 205 may extend across at least 50% of the thickness T1 of metallic web 202. Void space 205 within metallic web 202 may be a singular void space or a plurality of discrete and/or interconnected voids. Plurality of voids of void space 205 may have a diameter ranging from about 0.01 mm to about 4 mm, or about 50 microns to about 5000 microns. Plurality of voids of void space 205 may have a median diameter D50 from about 0.02 mm to about 4 mm, or about 200 microns to about 4000 microns. In an exemplary embodiment, the diameters of the plurality of voids of void space 205 are larger than particle sizes of insulation material 204 so the insulation material may be inserted into void space 205. Void space 205 of metallic web 202 may be a plurality of voids and extend at least 50% of the metallic web length, up to 100% of the metallic web length.

FIG. 4 illustrates a cross-section of metallic web 202 on surface 101 with thickness T1 according to an exemplary embodiment. Metal 203 of metallic web 202 is connected to metallic surface 101. In another embodiment, metal 203 of metallic web 202 is bonded to metallic surface 101 by metallic bonding, metal-to-metal bonding, or direct mechanical attachment. The connection between metal 203 and metallic surface 101 is configured such that its strength resists the combustion temperatures and pressures within combustion chamber 102 during operation of engine 100. For example, resistance to spalling of metal 203 from surface 101 may last for ≧100,000 miles inside operating engine 100. Metallic web 202 may be applied to surface 101 via 3-D printing, metallic plating, welding (arc, laser, plasma, or friction), brazing, plasma spraying, mechanical fastening, or other conventional methods of creating metallic bonding or metal-to-metal bonds.

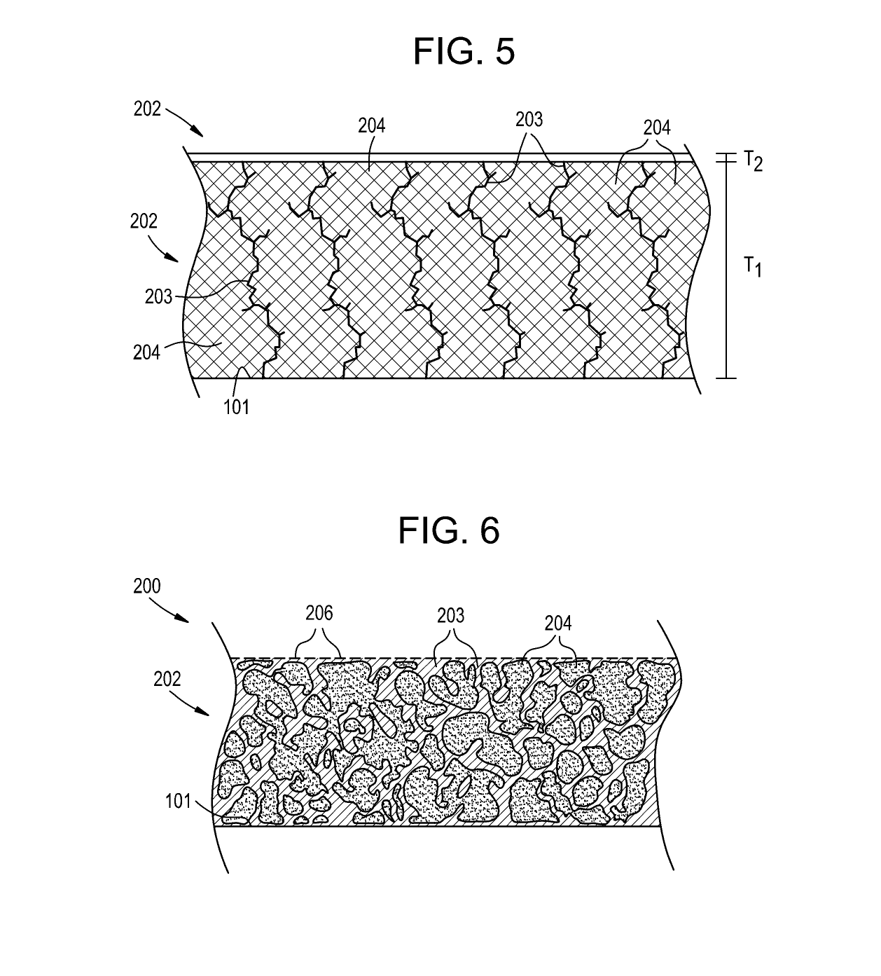

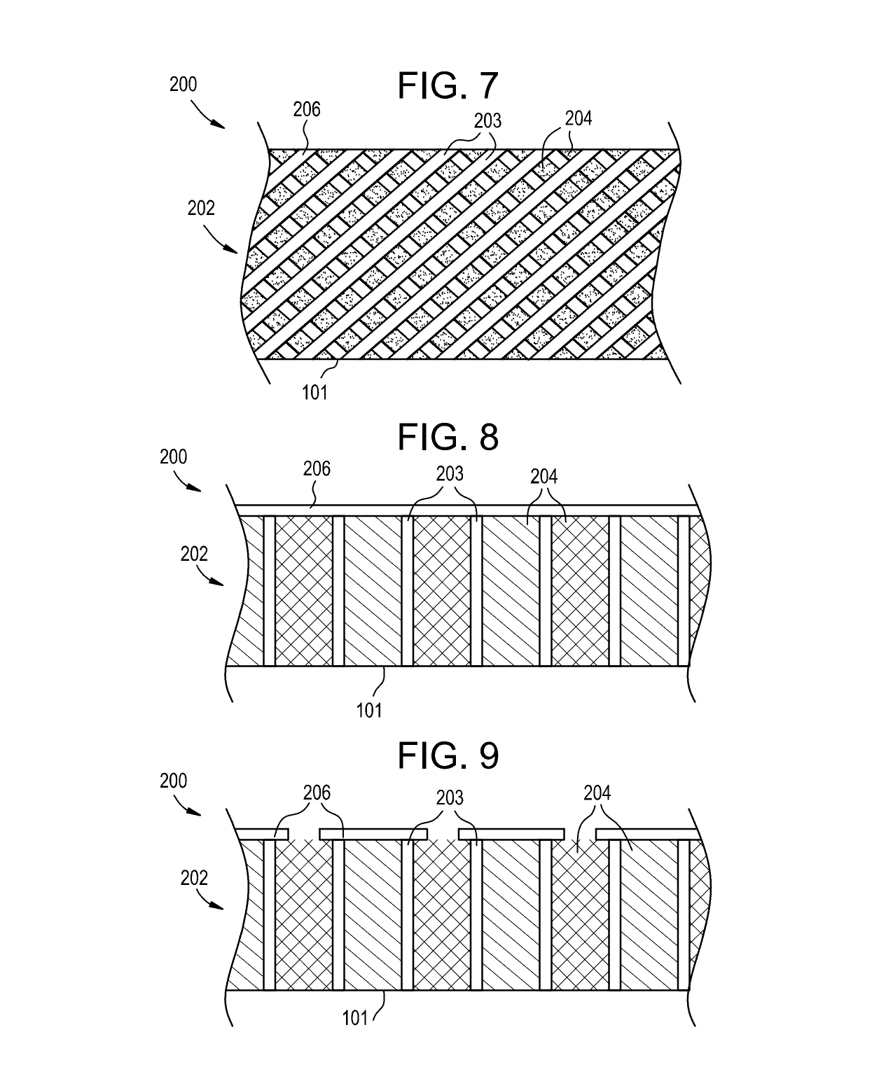

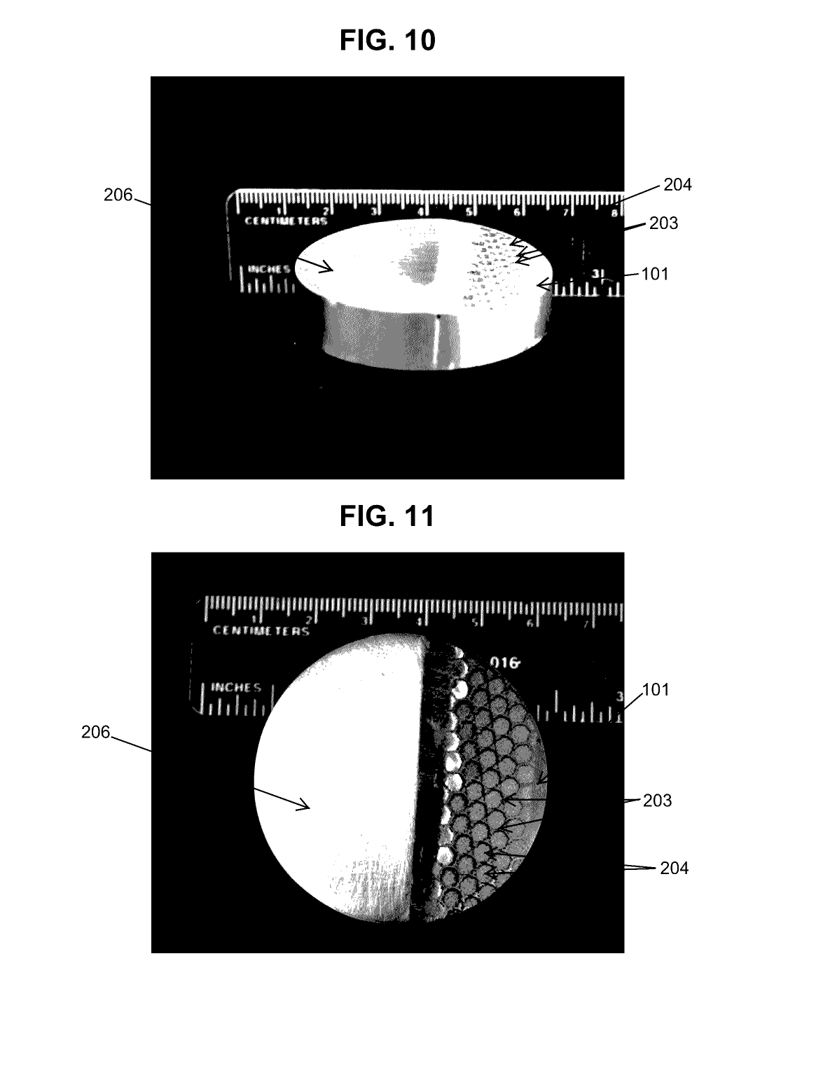

The structure of metal 203 within metallic web 202 is webbed. FIGS. 5-9 provide cross-sectional views of a number of exemplary embodiments for composite thermal barrier 200 on surface 101 and illustrating the webbed structure of metal 203 within metallic web 202. The webbed structure of metal 203 in metallic web 202 may also be described as dendritic, porous, latticed, pillared, sponge-like, meshed, barbed, or honeycomb-like. For example, the structure of metal 203 in FIGS. 4 & 5 may be described as dendritic. Metal 203 in FIG. 6 (shown as the hatched areas) can be described as sponge-like or barbed. The structure of metal 203 in FIG. 7 can be described as latticed or meshed. Further, the structure of metal 203 in FIGS. 8 & 9 can be described as pillared. The structure of metal 203 in FIGS. 10 & 11 can be described as honeycomb-like. The structure of metal 203 may also be hexagonal, triangular, pentagonal, septagonal or rectangular in shape. The structure of metal 203 may be a repeating mesh of the webbed structure and may include a plurality of cells as void space 205. Of course other configurations of metal 203 are in accordance with the present disclosure.

The structure of metal 203 in metallic web 202 is capable of retaining its shape on surface 101 and around void space 205. The structure of metal 203 is also capable of containing insulation material 204 within the void space. The structure of metal 203 acts as an anchor capable of interlocking insulation material 204 within the void space. The structure of metallic web 202 may be sufficiently rigid and has thermo mechanical fatigue resistance so as to withstand the combustion temperatures and pressures within combustion chamber 102 during operation of engine 100. The volume of metallic web 202 may be in any shape including, but not limited to, rectangular, cubic, annular, hemispherical, or cylindrical. The shape of the volume of metallic web 202 may also conform to the rounded or non-uniform shapes of surface 101 to which it is connected, including a curved piston top surface 120.

The length and width of metallic web 202 (including metal 203 and void space 205) can have any suitable lateral dimensions (e.g., from about 0.1 mm to about 100 cm), including equal dimensions. Thickness T1 of metallic web 202 may be from about 0.01 mm to about 10 mm, or from about 0.1 mm to about 2 mm, or from about 0.4 mm to about 2 mm, or even from about 0.5 mm to about 1 mm. In exemplary embodiments, thickness T1 is uniform across the length and the width of metallic web 202. Thickness T1 of metallic web 202 may be measured from surface 101 to a termination point of metallic web 202 away from surface 101. Thickness T1 may also be measured from surface 101 to an average thickness of metallic web 202 away from surface 101. Surface 101 within combustion chamber 102 may be identified from metallic web 202 by a lack of void space. That is, thickness T1 of metallic web 202 may be distinct from a thickness of material comprising surface 101 by the presence of void space 205 (or insulation material 204 filled therein) within thickness T1. Alternatively, metallic web 202 thickness T1 may be identified from surface 101 by a distinct interface of the connection caused by the application method.

Metal 203 within metallic web 202 may be an element or an alloy and may include metals and metal alloys commonly used in combustion chamber 102 manufacturing. Metal 203 may include carbon steel, stainless steel, alloy aluminum, aluminum, nickel plated aluminum, titanium, hastelloy, and combinations thereof for example. Metal 203 may also be other super alloys including nickel, chromium, cobalt, or combinations thereof. Metal 203 may have the same coefficient of thermal expansion (CTE) as the material encompassing surface 101 (assuming similar operating temperature ranges) to minimize thermal expansion stresses and failures at their connection. In an exemplary embodiment, the CTE of metal 203 may be within 150% of the CTE as the material encompassing surface 101 (assuming similar operating temperature ranges).

Composite thermal barrier 200 also includes insulation material 204. Insulation material 204 is contained with void space 205 of metallic web 202. In one embodiment, insulation material 204 is contained with the plurality of voids of void space 205. The presence of insulation material 204 within void space 205 of metallic web 202 inherently eliminates void space 205 within metallic web 202. Insulation material 204 may fill from 5% to 100% of void space 205. Referring back to FIG. 4, insulation material 204 (shown as a cross-hatched area) is contained within one of the plurality voids of void space 205. The volumetric ratio of metal 203 to insulation material 204 may be from about 1:1 to about 1:5. Insulation material 204 may have a density gradient along the thickness T1 of metallic web 202. The volumetric ratio, density, and location of insulation material 204 may allow for “tuning” of composite thermal barrier 202 to achieve a desired thermal conductivity.

In an exemplary embodiment, insulation material 204 is interlocked within the webbed structure of metal 203 such that it does not escape, spall, or flake out from metallic web 202 into combustion chamber 102 during operation of engine 100. FIG. 5 illustrates the metallic web of FIG. 4 with all of the plurality of voids of void space 205 filled with insulation material 204 (again, shown as cross-hatched areas). Similarly, FIGS. 6 & 7 illustrate insulation material 204 (shown as dark grey areas) surrounded by metal 203. Insulation material 204 of the present disclosure may be air, argon, nitrogen, helium, a ceramic material, and combinations thereof. Insulation material 204 of the present disclosure may also be a vacuum pressure less than atmospheric pressure. As shown in FIGS. 8 & 9, different insulation materials (shown as alternating cross-hatched and hatched areas) fill the plurality of voids (of void space 205). Insulation material 204 of the present disclosure may also be any material that is capable of flowing or being contained within void space 205 and with a thermal conductivity between about 0.1 W/m·K and about 12.0 W/m·K at 400° C., or about 0.1 W/m·K and about 8.0 W/m·K at 400° C., or even about 1.0 W/m·K and about 4.0 W/m·K at 400° C. Insulation material 204 is a composition having a low thermal conductivity within metallic web 202 to increase the thermal resistivity of composite thermal barrier 200 such that more energy of combustion is available for performing work and powering engine 100.

In an embodiment where insulation material 204 includes ceramic material, the ceramic material may have a porosity from about 10% to about 90%, or from about 30% to about 70%. The pores of the ceramic material may include air, argon, nitrogen, helium, and combinations thereof. Alternatively, the pores of the ceramic material may have a vacuum pressure less than atmospheric pressure. Example ceramic materials include, but are not limited to, yttria stabilized zirconia (YSZ), zirconium dioxide, lanthanum zirconate, gadolinium zirconate, lanthanum magnesium hexaaluminate, gadolinium magnesium hexaaluminate, lanthanum-lithium hexaaluminate, barium zirconate, strontium zirconate, calcium zirconate, sodium zirconium phosphate, mullite, aluminum oxide, cerium oxide, and combinations thereof. The ceramic material of exemplary embodiments may be ceramic foam. The ceramic material of exemplary embodiments may also be formed from aluminates, zirconates, silicates, titanates, and combinations thereof.

Composite thermal barrier 200 may also include a metallic skin 206. Metallic skin 206 has a length, a width, and a thickness T2. In one embodiment, metallic skin 206 is adjacent metallic web 202. Referring again to FIG. 5, metallic skin 206 is connected to metal 203 of metallic web 202 at the termination point of metallic web 202 away from surface 101. Metallic skin 206 is shown as solid along metallic web 202 length. Metallic skin 206 is configured to enclose insulation material 204 within metallic web 202 such that amounts of insulation material 204 are not lost into combustion chamber 102 during operation of engine 100. Metallic skin 206 is shown as a solid surface in FIG. 5. Accordingly, insulation material 204 contained within void space 205 of metallic web 202 is enclosed between metallic skin 206 and metallic surface 101. Metallic skin 206 may be used when the structure of metal 203 alone is insufficient to interlock insulation material 204 within the metallic web 202 during operation of the engine 100 without losing insulation material 204 into combustion chamber 102.

Metallic skin 206 may be an element or an alloy and may include metals and metal alloys (e.gs., aluminum, carbon steel, Inconel, etc.) commonly used in combustion chamber 102 manufacturing. Metallic skin 206 may be the same metal as metal 203, or different. In one embodiment, metallic skin 206 is the same as the material encompassing surface 101. In an exemplary embodiment, the CTE of metallic skin 206 is the same as the material encompassing surface 101 (assuming similar operating temperature ranges) such that they expand and contract at relatively the same rate. Alternatively, the CTE of metallic skin 206 may be within 150% of the CTE of the material encompassing surface 101. The CTE of metallic skin 206 may also be within 150% of the CTE of metal 203 (assuming similar operating temperature ranges) so as to minimize thermal expansion stresses and failures at their connection.

The length and width of metallic skin 206 can have any suitable lateral dimensions (e.g., from about 0.1 mm to about 100 cm), including equal dimensions. Metallic skin 206 lateral dimensions may extend across at least 50% of the length or the width of metallic web 202, up to 100%. Accordingly, metallic skin 206 may include plurality of discrete lengths and widths. FIGS. 6 & 9 illustrate a cross-section of composite thermal barrier 200 accordingly to exemplary embodiments with metallic skin 206 extending along less than the entire metallic web 202 length or width. Metallic skin 206 may be configured to have discrete lengths and widths (thereby minimizing the amount of high thermally conductive material exposed to combustion chamber 102), but positioned on metallic web 202 so as to contain or interlock insulation material 204 within the metallic web 202.

Thickness T2 of metallic skin 206 may be from about 0.001 mm to about 5 mm, or from about 0.1 mm to about 2 mm, or even from about 0.1 mm to about 1 mm. In exemplary embodiments, thickness T2 is uniform across the length and the width of metallic web 202. As shown in FIG. 5, thickness T2 of metallic skin 206 may be measured from the termination point of metallic web 202 to a surface of metallic skin 206. Metallic skin 206 may be identified from metallic web 202 by a lack of void space along thickness T2. That is, thickness T2 of metallic skin 206 may be distinct from thickness T1 of metallic web 202 by the presence of void space 205 (or insulation material 204 filled therein) within thickness T1. Metallic skin may have a variation tolerance along its combustion chamber exposed surface in compliance with tolerances required for engine 100, such as ≦1 mm, or ≦0.01 mm.

Again, composite thermal barrier 200 of the present disclosure includes metallic web 202 and insulation material 204. Composite thermal barrier 200 may also include metallic skin 206 adjacent metallic web 202 that may assist in containing insulation material 204 within metallic web 202 so it does not spall or flake out into combustion chamber 102 during operation of engine 100. In an exemplary embodiment, composite thermal barrier 200 has a thermal conductivity of about 0.1 W/m·K to about 12 W/m·K at 400° C., or about 1 W/m·K to about 5 W/m·K at 400° C. Various embodiments of composite thermal barrier 200 on a surface within engine 100 are provided in FIGS. 4-9. Of course, combinations of these embodiments and other embodiments are in accordance with this disclosure.

The present disclosure also includes methods of applying composite thermal barrier 200 to metallic surface 101 within combustion chamber 102 of engine 100. The method includes preparing metallic surface 101 for application of metallic web 202. Preparing metallic surface 101 may include roughening, chemical etching, drilling, cleaning, or other processes of readying surface 101 for application of metallic web 202 thereon. It is envisioned that the method of preparation of surface 101 will likely depend on the method of applying metallic web 202 on surface 101.

The method of applying composite thermal barrier 200 to metallic surface 101 includes applying metallic web 202 to surface 101. Applying metallic web 202 to surface 101 may be accomplished with 3-D printing, metallic plating, mechanical fastening or threading, fusion welding, brazing, resistance welding, diffusion bonding, sintering, or other conventional methods of metallically bonding metal 203 to surface 101 via metal-to-metal bonds. Methods of applying metallic web 202 to surface 101 include the formation of void space 205 around metal 203 within metallic web 202. These methods are also applicable to forming metallic skin 206 adjacent to metallic web 202.

The method of applying composite thermal barrier 200 to metallic surface 101 also includes inserting insulation material 204 within void space 205 of the metallic web 202. Methods of inserting insulation material 204 within void space 205 include pressure application, injection, pressing, impregnating, and other conventional methods of inserting a solid or gas insulator in void space 205. It is envisioned that inserting insulation material 204 within void space 205 may be accomplished while applying metallic web 202 to surface 101, when metallic web includes void space 205 with an insulation material (e.g., air, vacuum, etc.) already present.

The method of applying composite thermal barrier 200 to metallic surface 101 may also include forming metallic skin 206 adjacent to metallic web 202. Methods of forming metallic skin 206 adjacent to metallic web 202 may include 3-D printing, metallic plating, welding (arc, laser, plasma, or friction), brazing, plasma spraying, mechanical fastening, dip coating, deposition, and other conventional methods of forming a uniform metallic skin on the periphery of a metallic web. These methods are also applicable to applying metallic web 202 to surface 101.

Alternative methods include forming metal 203 on metallic skin 206 prior to applying metal 203 to surface 101. In this embodiment, metal 203 may be formed on metallic skin 206 by sheet metal fabrication, superplastic forming, hydroforming, chemical etching, electrical discharge machining, mechanical milling, pressing and sintering, and other similar processes. Subsequently, metal 203 is applied or connected to surface 101 by above mentioned methods.

### EXAMPLES

The present disclosure will be further clarified with reference to the following examples. The following examples should be construed as illustrative and in no way limiting as to the present disclosure.

### Modeling Example 1

The effective thermal conductivity of theoretical composite thermal barriers where modeled using the following equation:

$$= {\sum }_{i = 1}^{n} {φ}_{i} {k}_{i}$$

where [symbol] is effective thermal conductivity of composite thermal barrier 200 in W/m·K, where kᵢ is the thermal conductivity of a component (e.g., metal 203) in W/m·K, and wherein φᵢ is volume fraction of a component.

Using the above referenced equation, the volume fractions of a metal component (which could be metal 203 with or without metallic skin 206) and an insulation component (insulation material 204) where varied for Examples 1-13 to model a composite thermal barrier (CTB). Tables 1a and 1b provide the relative fractions and materials for each of Examples 1-13 and comparative examples (CE) 1-4. Tables 1a and 1b also provide the modeled thermal properties of including the CTB thermal conductivity, CTB effective density, CTB effective heat capacity, and CTB thermal diffusivity. Also shown is the thickness of the CTB modeled to effectively function when exposed to a combustion environment at 2000° C. when the piston surface is at 400° C., and maximum temperature increase at thickness depth of 250° C.

TABLE 1a
Modeled Composite Thermal Barriers (CTB)

| | | Examples | | | | | | | |
|---|---|---|---|---|---|---|---|---|---|
| | | 1 | 2 | 3 | 4 | 5 | 6 | 7 | 8 |
| CTB | Metal | 316 | 316 | 316 | 316 | 316 | 316 | 316 | 316 |
| | | SS | SS | SS | SS | SS | SS | SS | SS |
| | Ceramic | YSZ | YSZ | YSZ | YSZ | YSZ | YSZ | YSZ | YSZ |

| | | | | | | | | |
|---|---|---|---|---|---|---|---|---|
| Gas within void | Air | Air | Air | Air | Air | Air | Air | Air |
| space or ceramic | | | | | | | | |
| porosity | | | | | | | | |
| CTB Metal | 0.1 | 0.2 | 0.3 | 0.4 | 0.5 | 0.6 | 0.7 | 0.8 |
| Volume Fraction | | | | | | | | |
| CTB Ceramic | 0.9 | 0.8 | 0.7 | 0.6 | 0.5 | 0.4 | 0.3 | 0.2 |
| Volume Fraction | | | | | | | | |
| CTB Gas Volume | 0.0 | 0.0 | 0.0 | 0.0 | 0.0 | 0.0 | 0.0 | 0.0 |
| Fraction | | | | | | | | |
| Ceramic Porosity | 0.0 | 0.0 | 0.0 | 0.0 | 0.0 | 0.0 | 0.0 | 0.0 |
| CTB Thickness | 0.6 | 0.7 | 0.8 | 0.9 | 0.9 | 1.0 | 1.1 | 1.1 |
| (mm) | | | | | | | | |
| CTB Effective | 3.3 | 4.5 | 5.7 | 6.9 | 8.1 | 9.2 | 10.4 | 11.6 |
| Thermal | | | | | | | | |
| Conductivity | | | | | | | | |
| (W/m · K) | | | | | | | | |
| CTB Effective | 6185 | 6370 | 6555 | 6740 | 6925 | 7110 | 7295 | 7480 |
| Density (km/m³) | | | | | | | | |
| CTB Effective | 625 | 602 | 580 | 560 | 540 | 521 | 504 | 487 |
| Heat Capacity | | | | | | | | |
| (J/kg/K) | | | | | | | | |
| CTB Effective | 8.6E−7 | 1.2E−6 | 1.5E−6 | 1.8E−6 | 2.2E−6 | 2.5E−6 | 2.8E−6 | 3.2E−6 |
| Thermal | | | | | | | | |
| Diffusivity (m²/s) | | | | | | | | |

TABLE 1b
Modeled CTBs Cont'd with 4 Comparative Examples (CE)

| | | Examples | | | | | | | | |
|---|---|---|---|---|---|---|---|---|---|---|
| | | 9 | 10 | 11 | 12 | 13 | CE 1 | CE 2 | CE 3 | CE 4 |
| CTB | Metal | 316 | 316 | 316 | 316 | 316 | Carbon | Al | 316 | 316 |
| | | SS | SS | SS | SS | SS | steel | | SS | SS |
| | Ceramic | YSZ | YSZ | YSZ | YSZ | YSZ | YSZ | YSZ | YSZ | YSZ |

| | | | | | | | | | |
|---|---|---|---|---|---|---|---|---|---|
| Gas | Air | Air | Air | Air | Air | Air | Air | Air | Air |
| CTB Metal | 0.2 | 0.2 | 0.2 | 0.4 | 0.4 | 1.0 | 1.0 | 1.0 | 0.0 |
| Volume Fraction | | | | | | | | | |
| CTB Ceramic | 0.6 | 0.4 | 0.0 | 0.4 | 0.0 | 0.0 | 0.0 | 0.0 | 1.0 |
| Volume Fraction | | | | | | | | | |
| CTB Gas Volume | 0.2 | 0.4 | 0.8 | 0.2 | 0.6 | 0.0 | 0.0 | 0.0 | 0.0 |
| Fraction | | | | | | | | | |
| Ceramic Porosity | 0.25 | 0.50 | 0.00 | 0.33 | 0.00 | 0.00 | 0.00 | 0.00 | 0.00 |
| CTB Thickness | 0.7 | 0.7 | 1.6 | 0.9 | 1.4 | 2.1 | 5.3 | 1.3 | 0.5 |
| (mm) | | | | | | | | | |
| CTB Effective | 3.6 | 3.1 | 4.5 | 6.0 | 6.9 | 38.0 | 167.0 | 14.0 | 2.1 |
| Thermal | | | | | | | | | |
| Conductivity | | | | | | | | | |
| (W/m · K) | | | | | | | | | |
| CTB Effective | 5170 | 3970 | 1570 | 5540 | 3140 | 7850 | 2700 | 7850 | 6000 |
| Density (km/m³) | | | | | | | | | |
| CTB Effective | 591 | 573 | 456 | 540 | 456 | 456 | 896 | 456 | 650 |
| Heat Capacity | | | | | | | | | |
| (J/kg/K) | | | | | | | | | |
| CTB Effective | 1.2E−6 | 1.4E−6 | 6.3E−6 | 2.0E−6 | 4.8E−6 | 1.1E−5 | 6.9E−5 | 3.9E−6 | 5.4E−7 |
| Thermal | | | | | | | | | |
| Diffusivity (m²/s) | | | | | | | | | |

The 14 modeled composite thermal barriers (CTB) in Table 1a and Table 1b provide that a CTB thickness from about 0.5 mm to about 2 mm on a steel piston have an effective thermal conductivity of the modeled examples of the present disclosure are from about 3.0 W/m·K to about 12 W/m·K. These modeled example CTBs also have an effective thermal diffusivity from about 8.0E-7 to about 7.0E-6. Comparative example 4 provides an example prior art CTB where the insulation material (YSZ) is not held within a metallic web according to the present disclosure.

FIGS. 10 & 11 provide photographs of an example CTB 200 with a metallic skin 206 on an example surface 101. A portion of metallic skin 206 is removed on the right side of the coupon to show the 1.5 mm thick metallic web 202 and 0.5 mm thick metallic skin 206.

### Example 2

Five composite thermal barriers (Examples 2-6) in accordance with the present disclosure were prepared on direct metal laser sintered coupons (simulating an engine internal surface) and tested under severe thermal cycling (up to 50 cycles) to demonstrate thermal resistivity and spalling resistance.

The first composite thermal barrier was prepared on a 50 mm square by 12 mm thick F75 cobalt-chrome (Co—Cr) block coupon. A metallic web of F75 Co—Cr was direct metal laser sintered onto the coupon. The metallic web was in the shape of a plurality of 1.15 mm diameter posts (each 1.5 mm tall on the coupon flat surface) each equally spaced apart in a triangular array. The coupon also included a raised edge along its perimeter 1.15 mm wide and 1.5 mm tall. The metallic web included 90% open frontal area (OFA) across its thickness (i.e., between the surface of the coupon and the termination ends of the plurality of posts). A 100 micron bond coat of nickel chromium aluminum yttrium (NiCrAlY) was applied to the surface of the coupon around the plurality of posts. YSZ was plasma sprayed over the NiCrAlY to fill the void space (defined by the OFA and the thickness of the plurality of the posts) around the metallic web. Excess YSZ extending above the termination ends of the plurality of posts was diamond ground so the YSZ was flush with the termination ends of the plurality of posts. The YSZ had porosity of about ≦1%.

The first composite thermal barrier coupon was tested by repeatedly heating and air cooling in increments of 10 cycles. The thermal barrier was then inspected for signs of damage or spalling of the insulation material from the void space around the metallic web. To record temperature and heat conduction across the thermal barrier during testing, a needle thermocouple was provided through a small hole in the bottom of the coupon to about 0.5 mm below the surface on which the thermal barrier was connected. During heating in each cycle, the thermal barrier coupon was direct flame heated for 30 seconds with a 2-stage Bethlehem Champion lampworking torch (using the inner burner ring only). The torch face was oriented normal to and 4 inches from the top of the thermal barrier. The torch was supplied with about 6 standard cubic feet per minute (SCFM) of natural gas and about 15 SCFM of pure oxygen gas. After 30 seconds of heating, the thermal barrier was cooled using a Vortec® Model 631 Cold Air Gun supplied with about 20 SCFM of air at about 12° C. The air gun was oriented normal to and 4 inches from the top of the thermal barrier. During each cycle, the thermal barrier coupon was cooled until the thermocouple read about 100° C. (i.e., about 3.5 minutes). The heating and cooling described above was considered a single cycle. After 10 cycles of each sequential heating and cooling operation, the first thermal barrier coupon was inspected under a microscope at about 10× magnification for visible signs of spalling, delamination of the thermal barrier from the coupon surface, and/or cracks in the metallic web or the insulation material (YSZ). The above described testing is considered severe thermal cycling and was conducted to simulate the most extreme conditions that a thermal barrier would experience in a combustion engine. Of course, in some engines a thermal barrier would not experience such extreme temperature swings and may exhibit improved performance over the results observed.

The above described testing of the first thermal barrier was repeated for 11 cycles. After the initial cycle, small visible cracks in the YSZ material were present between a majority of the plurality of posts. During the subsequent 10 cycles, the cracks in the YSZ material continued to propagate between all of the posts. Testing was stopped after 11 cycles despite no delamination or spalling of YSZ from the metallic web. The average peak temperature recorded by the thermocouple (at 0.5 mm below the surface on which the thermal barrier was connected) was about 467° C.

### Example 3

The second composite thermal barrier was prepared on a 50 mm square by 12 mm thick F75 Co—Cr block coupon. A metallic web of F75 Co—Cr was direct metal laser sintered onto the coupon similar to that pictured in FIGS. 10 and 11 (without skin 206). The metallic web was in the shape of a plurality of interconnected uniform walls forming an array of hexagonal cells, each wall 1.15 mm wide and 1.5 mm tall on the coupon flat surface and spaced apart in a hexagonal array. The coupon also included a raised edge along its perimeter 1.15 mm wide and 1.5 mm tall. The metallic web included 90% OFA across its thickness (i.e., between the surface of the coupon and the termination ends of the plurality of walls). A 100 micron bond coat of NiCrAlY was applied to the surface of the coupon around the plurality of walls (i.e., inside each hexagonal cell). YSZ was plasma sprayed over the NiCrAlY to fill the void space (defined by the OFA and the thickness of the plurality of the walls) around the metallic web. Excess YSZ extending above the termination ends of the plurality of walls was diamond ground so the YSZ was flush with the termination ends of the plurality of posts. The YSZ had porosity of about ≦1%.

The testing described in Example 2 above was conducted on the second thermal barrier for 50 cycles. No visible signs of failure or delamination were observed. Testing was stopped after 50 cycles as it was determined the thermal barrier had provided superior resistance to spalling via thermal cycling. The average peak temperature recorded by the thermocouple (at 0.5 mm below the surface on which the thermal barrier was connected) was about 430° C. In was unexpected that the configuration of the metallic web of the second thermal barrier (titled hexagons) and the discrete portions of YSZ therebetween resulted in less thermal related cracking of the YSZ from thermal cycling.

### Example 4

The third composite thermal barrier was prepared on a 50 mm square by 12 mm thick F75 Co—Cr block coupon. A metallic web of F75 Co—Cr was direct metal laser sintered onto the coupon. The metallic web was in the shape of a plurality of 1.15 mm diameter posts (each 1.5 mm tall on the coupon flat surface) each equally spaced apart in a triangular array. The coupon also included a raised edge along its perimeter 1.15 mm wide and 1.5 mm tall. The metallic web included 90% OFA across its thickness (i.e., between the surface of the coupon and the termination ends of the plurality of posts). A 100 micron bond coat of NiCrAlY was applied to the surface of the coupon around the plurality of posts. YSZ was plasma sprayed over the NiCrAlY to fill the void space (defined by the OFA and the thickness of the plurality of the posts) around the metallic web. Excess YSZ extending above the termination ends of the plurality of posts was diamond ground so the YSZ was flush with the termination ends of the plurality of posts. The YSZ had porosity of about ≦1%. Finally, a 0.5 mm thick metal alloy (95% nickel, 5% aluminum) continuous skin was plasma sprayed over the top of the YSZ in contact with the termination ends of the plurality of posts.

The testing described in Example 2 above was conducted on the third thermal barrier for 50 cycles. After less than about 10 cycles, the skin was visibly cracked at the center of the coupon. After about 35 cycles, the skin was severely cracked and began separating or delaminating from the coupon at the center thereof. Testing was stopped after 50 cycles and no cracking or delamination of the YSZ insulation material was observed. The average peak temperature recorded by the thermocouple (at 0.5 mm below the surface on which the thermal barrier was connected) was about 343° C. These results were unexpected compared to the first thermal barrier because the barrier provided increased thermal resistivity as shown by the lower peak temperature below the barrier. Also, the presence of the metallic skin in the thermal barrier resulted in less visible thermal related cracking of the YSZ from thermal cycling.

### Example 5

The fourth composite thermal barrier was prepared on a 50 mm diameter by 12 mm thick F75 Co—Cr cylindrical coupon. A metallic web of F75 Co—Cr was direct metal laser sintered onto the coupon. The metallic web was in the shape of a plurality of 1.15 mm diameter posts (each 1.5 mm tall on the coupon flat surface) each equally spaced apart in a triangular array. The coupon also included a raised edge along its perimeter 1.15 mm wide and 1.5 mm tall. The metallic web included 90% OFA across its thickness. No bond coat or YSZ was included. Instead the void space was filled with air as the insulation material. A 0.5 mm thick Co—Cr continuous skin was direct metal laser sintered over the top of the metallic web in contact with the termination ends of the plurality of posts.

The testing described in Example 2 above was conducted on the fourth thermal barrier for 50 cycles. After about 30 cycles, the skin began to visibly crack. Testing was stopped after 50 cycles with no severe cracking or delamination of the skin. The average peak temperature recorded by the thermocouple (at 0.5 mm below the surface on which the thermal barrier was connected) was about 528° C.

### Example 6

The fifth composite thermal barrier was prepared on a 50 mm diameter by 12 mm thick F75 Co—Cr cylindrical coupon. A metallic web of F75 Co—Cr was direct metal laser sintered onto the coupon. The metallic web was in the shape of a plurality of 1.15 mm diameter posts (each 1.5 mm tall on the coupon flat surface) each equally spaced apart in a triangular array. The coupon also included a raised edge along its perimeter 1.15 mm wide and 1.5 mm tall. The metallic web included 75% OFA across its thickness. No bond coat or YSZ was included. Instead the void space was filled with air as the insulation material. A 0.5 mm thick Co—Cr alloy continuous skin was direct metal laser sintered over the top of the metallic web in contact with the termination ends of the plurality of posts.

The testing described in Example 2 above was conducted on the fourth thermal barrier for 70 cycles. No visible signs of cracking were observed after 50 heating and cooling cycles. After about 70 cycles, the skin began to visibly crack at the center of the coupon. Testing was stopped after 70 cycles with no severe cracking or delamination of the skin. The average peak temperature recorded by the thermocouple (at 0.5 mm below the surface on which the thermal barrier was connected) was about 570° C.

### Prophetic Example 7

In this prophetic example, the five composite thermal barriers (from Examples 2-6 described above) would be subjected to pressure, pulsation, and/or vibration testing to simulate exposure of the composite thermal barrier to the combustion reaction and movement of fluids inside the combustion chamber. Specifically, a hydro pulse system could deliver from about 1 psi to about 5000 psi pressurized hydraulic fluid (or similar fluid chosen to mimic combustion reactants) at about 30 Hertz (or another frequency chosen to mimic an internal combustion engine) normal to the face of the five composite thermal barriers (from Examples 2-6 described above). It is expected that these five thermal barriers would behave similar to surfaces within combustion engines that do not include thermal barriers. That is, these five composite thermal barriers would resist metal fatigue and would effectively limit spalling or delamination of the insulation material into the engine. The inventors expect that the second composite thermal barrier of Example 3 would spall a small portion of the YSZ material from the hexagonal cells into the engine during this prophetic test. However, the inventors expect that it would not be a catastrophic failure in which all of the YSZ material would spall into the engine simultaneously and damage crucial internal engine parts. The inventors also expect that the third, fourth, and fifth composite thermal barriers (of Examples 4-6) which include a skin would even more effectively resist this testing and limit spalling or delamination of material into the engine.

### Comparative Example 1

Two conventional thermal barriers were prepared on coupons (simulating an engine internal surface) and tested under severe thermal cycling (up to 50 cycles) to demonstrate the superior thermal resistivity and spalling resistance of the composite thermal barriers of the present disclosure (and demonstrated in Example 2 above).

The first comparative thermal barrier was prepared on a 50 mm diameter by 12 mm thick F75 Co—Cr cylindrical coupon. No metallic web was applied thereto. A 100 micron bond coat of NiCrAlY was applied to the entire surface of the coupon. A YSZ layer was plasma sprayed over the NiCrAlY and diamond ground down to uniform 2.0 mm layer thereon. No metallic skin was applied.

The testing described in Example 2 above was conducted on the first comparative thermal barrier for 11 cycles. After the initial heating-cooling cycle, small visible cracks in the YSZ material were visible. After the subsequent 2 cycles, the cracks in the YSZ material continued to propagate and the YSZ began to delaminate from the surface of the coupon. Testing was stopped after 11 cycles as the YSZ almost completely delaminated from the coupon and it was determined that the thermal barrier had failed. The average peak temperature recorded by the thermocouple (at 0.5 mm below the surface on which the YSZ was connected) was about 369° C.

### Comparative Example 2

The second comparative thermal barrier was prepared on a 50 mm diameter by 12 mm thick F75 Co—Cr cylindrical coupon. No metallic web was applied thereto. A 100 micron bond coat of NiCrAlY was applied to the entire surface of the coupon. A YSZ layer was plasma sprayed over the NiCrAlY and diamond ground down to uniform 1.0 mm layer thereon. No metallic skin was applied.

The testing described in Example 2 above was conducted on the second comparative thermal barrier for 50 cycles. After the first 2 cycles, extensive “mud puddle” cracks across the surface of the YSZ material were visible. During the subsequent about 40 cycles, the “mud puddle” cracks in the YSZ material continued to propagate. Testing was stopped after 50 cycles. The average peak temperature recorded by the thermocouple (at 0.5 mm below the surface on which the YSZ was connected) was about 478° C.

### Comparative Example 3

In a third comparative example, a 50 mm diameter by 12 mm thick F75 Co—Cr cylindrical coupon was prepared to simulate an engine surface without any thermal barrier. The testing described in Example 2 above was conducted on the third comparative thermal barrier for 1 cycle. The average peak temperature recorded by the thermocouple (at 0.5 mm below the surface on which the flame was directed) was about 705° C.

### Prophetic Comparative Example 4

In this prophetic comparative example, the 2 thermal barriers (from Comparative Examples 1-2 described above) would be subjected to pressure, pulsation, and/or vibration testing described in Prophetic Example 7 above. It is expected that these two composite thermal barriers would behave similar to conventional thermal barriers inside of combustion engines. That is, with the brittle ceramic material directly exposed to the pressurized fluid, the inventors expect rapid failure of the conventional thermal barrier and immediately delamination of the ceramic from the coupon surface.

As used herein, the singular forms “a,” “an,” and “the” include plural referents unless the context clearly dictates otherwise. Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

It is also noted that recitations herein refer to a component of the present disclosure being “configured” or “adapted to” function in a particular way. In this respect, such a component is “configured” or “adapted to” embody a particular property, or function in a particular manner, where such recitations are structural recitations as opposed to recitations of intended use. More specifically, the references herein to the manner in which a component is “configured” or “adapted to” denotes an existing physical condition of the component and, as such, is to be taken as a definite recitation of the structural characteristics of the component.

It will be apparent to those skilled in the art that various modifications and variations can be made to the present disclosure without departing from the spirit and scope hereof. Since modifications combinations, sub-combinations and variations of the disclosed embodiments incorporating the spirit and substance of the disclosure may occur to persons skilled in the art, the present disclosure should be construed to include everything within the scope of the appended claims and their equivalents.

What is claimed is:

1. A composite thermal barrier for a metallic surface within an engine, the composite thermal barrier comprising:
a metallic web comprising a metal and a void space, the metallic web having a volume defined by a length, a width, and a thickness,
the metal of the metallic web connects to a metallic surface within a combustion chamber in an engine, and
an insulation material contained within the void space of the metallic web.

2. The composite thermal barrier of claim 1 wherein the insulation material is selected from the group consisting of air, argon, nitrogen, helium, a ceramic material, and combinations thereof.

3. The composite thermal barrier of claim 1 wherein the ceramic material has a porosity from about 10% to about 90%.

4. The composite thermal barrier of claim 1 the ceramic material comprises yttria stabilized zirconia, zirconium dioxide, lanthanum zirconate, gadolinium zirconate, lanthanum magnesium hexaaluminate, gadolinium magnesium hexaaluminate, lanthanum-lithium hexaaluminate, barium zirconate, strontium zirconate, calcium zirconate, sodium zirconium phosphate, mullite, aluminum oxide, cerium oxide, or combinations thereof.

5. The composite thermal barrier of claim 1 wherein the insulation material is a pressure less than atmospheric pressure.

6. The composite thermal barrier of claim 1 wherein the metallic web thickness ranges from about 0.5 mm to about 5 mm.

7. The composite thermal barrier of claim 1 wherein the metallic web volume comprises from 50% to 98% void space.

8. The composite thermal barrier of claim 1 wherein the void space of the metallic web is a plurality of voids across at least 50% of the metallic web length.

9. The composite thermal barrier of claim 1 wherein the volumetric ratio of the metal of the metallic web to the insulation material is from 1:1 to 1:5.

10. The composite thermal barrier of claim 1 further comprising a metallic skin adjacent the metallic web.

11. The composite thermal barrier of claim 10 wherein the metallic skin is substantially solid.

12. The composite thermal barrier of claim 10 wherein the insulation material contained within the void space of the metallic web volume is enclosed between the metallic skin and the metallic surface.

13. The composite thermal barrier of claim 10 wherein the metallic skin has a thickness from about 0.001 mm to about 2 mm.

14. The composite thermal barrier of claim 10 wherein the metallic skin extends across at least 50% of the length of the metallic web.

15. The composite thermal barrier of claim 1 having a thermal conductivity of about 0.1 W/m·K to about 12 W/m·K at 400° C.

16. A composite thermal barrier for a metallic component surface within a combustion chamber of an internal combustion engine, the composite thermal barrier comprising:
a metallic web comprising a metal and a plurality of void spaces, the metallic web having a length, a width, and a thickness,
the metal of the metallic web is connected to a metallic component surface within a combustion chamber volume of an internal combustion engine, and
an insulation material contained within the plurality of voids of the metallic web.

17. The composite thermal barrier of claim 16 further comprising a metallic skin that encloses the insulation material within the metallic web.

18. The composite thermal barrier of claim 16 wherein the metal of the metallic web comprises carbon steel, stainless steel, alloy aluminum, nickel plated aluminum, titanium, hastelloy, or combinations thereof.

19. The composite thermal barrier of claim 16 wherein the combustion chamber volume is a chamber compression volume.

20. The composite thermal barrier of claim 16 wherein the combustion chamber volume is a chamber exhaust volume.

21. A method of applying the composite thermal barrier of claim 1 to a metallic surface within a combustion chamber of an engine, the method comprising:
preparing a metallic surface within a combustion chamber of an engine for application of a metallic web,
applying the metal of the metallic web to the metallic surface, and
inserting the insulation material within the void space of the metallic web.

22. The method of claim 21 further comprising forming a metallic skin adjacent to the metallic web to enclose the insulation material within the metallic web volume.
